(19) United States
(12) Patent Application Publication
(10) Pub. No.: US 2015/0183678 A1
(43) Pub. Date: Jul. 2, 2015

(54) METHOD OF CUTTING A NON-METALLIC MATERIAL ALONG A CURVED LINE

(71) Applicant: RORZE SYSTEMS CORPORATION, Yongin-si, Gyeonggi-do (KR)

(72) Inventors: Hyuk Park, Seoul (KR); Chan-Gwi Kim, Yongin-si (KR); Seong-Wook Moon, Yongin-s (KR)

(21) Appl. No.: 14/004,412

(22) PCT Filed: Jul. 18, 2013
(86) PCT No.: PCT/KR2013/006420

§ 371 Date: Sep. 10, 2013

(30) Foreign Application Priority Data
Sep. 11, 2012 (KR) 10-2012-0100391

(51) Int. Cl. C03B 33/09; B23K 26/00

(52) U.S. Cl. CPC C03B 33/091; B23K 26/0087; B23K 26/0069

(57) ABSTRACT

A method of cutting a non-metallic material along a curved line, is disclosed. The method includes forming an initial crack on a surface of a non-metallic material such that the initial crack is disposed on a curved line along which the non-metallic material is cut, and irradiating a laser beam along the curved line to apply thermal shock to propagate along the curved line to cut the non-metallic material along the curved line. Therefore, edge portions of the non-metallic material may not be damaged and the non-metallic material may be clearly and quickly cut.

### TECHNICAL FIELD

Exemplary embodiments of the present invention relate to a method of cutting a non-metallic material along a curved line. More particularly, exemplary embodiments of the present invention relate to a method of cutting a non-metallic material such as a tempered glass along a curved line.

### BACKGROUND ART

In general, in order to cut a corner portion of a non-metallic material such as a tempered glass substrate along a curved line, a physical method using a diamond wheel and grinder, a chemical method such as a wet etching, and a direct ablation using a laser may be used.

According to the physical method using diamond wheel and a grinder, it takes relatively long time and generates crack and particles.

According to the wet etching method, it also takes relatively long time, induces environmental pollution, and has relatively lower productivity.

According to the direct ablation using a laser, it generates chip and particles, induces thermal damages at a cutting section, and takes relatively long time.

Further, it is difficult to cut a non-metallic material such as a tempered glass substrate along a curved line.

FIG. 1A is a schematic view showing a conventional method of cutting a tempered glass substrate by using a laser.

As shown in FIG. 1A, according to a conventional method of cutting a tempered glass substrate by using a laser, an initial crack 20 is formed at an edge portion of a tempered glass substrate 10 by using an initial cracker 30.

When the initial crack 20 is formed at the edge portion of the tempered glass substrate 10, a laser beam 40 is irradiated onto the tempered glass substrate 10 from the initial crack 20 to generate a scribing line, and a coolant is sprayed onto the scribing line by using a quenching nozzle 50 to cut the tempered glass substrate 10.

When the glass tempered glass substrate is cut by using the above-mentioned method, the initial crack 20 propagates up to a specific length along the scribing line, and then propagates other direction losing linearity. Therefore, it is hard to cut the tempered glass substrate 10 with large size.

FIG. 1B is a schematic view showing a conventional method of cutting a cutting a tempered glass substrate along a curved line by using a laser.

Referring to FIG. 1B, according to a conventional method of cutting a tempered glass substrate along a curved line, an initial crack 20 is formed slantly or curvedly at an edge portion e of the tempered glass substrate 10.

When the initial crack 20 is formed slantly or curvedly at an edge portion e of the tempered glass substrate 10, a laser beam is irradiated along a curved line to cut the tempered glass substrate 10.

However, according to the above method, the initial crack 20 is formed at the edge e of the tempered glass substrate 10 so that edge portion e of the tempered glass substrate 10 may be broken to deteriorate quality of product, and the tempered glass substrate 10 may not clearly cut.

### DISCLOSURE

### Technical Problem

Exemplary embodiments of the present invention provide a method of cutting a non-metallic material such as a tempered glass substrate along a curved line, which is capable of reducing cutting time and cutting clearly.

### Technical Solution

The method of cutting a non-metallic material along a curved line, includes forming an initial crack on a surface of a non-metallic material such that the initial crack is disposed on a curved line along which the non-metallic material is cut, and irradiating a laser beam along the curved line to apply thermal shock to propagate along the curved line to cut the non-metallic material along the curved line.

Preferably, the initial crack may be symmetrically formed with respect to a center line dividing a corner of the non-metallic material along the curved line to have a fixed depth.

The initial crack may be formed on the surface of the non-metallic material along the curved line not to extend to two opposite ends of the curved line.

The initial crack may be formed on the surface of the non-metallic material through a contact method.

For example, the initial crack may be formed by contacting rotating wheel to the surface of the non-metallic material.

Alternatively, the initial crack may be formed on the surface of the non-metallic material through a non-contact method.

For example, the initial crack may be formed by irradiating laser beam.

The laser beam may be irradiated along the curved line at least one time.

### Advantageous Effects

According to the method of cutting a non-metallic material along a curved line of the present invention, the initial crack is formed a center portion of the curved line along which the tempered glass substrate is cut so that the edge portion of the non-metal substrate may be clearly cut and not be fractured.

Additionally, when the laser beam is irradiated along the curved line on the non-metallic material, the initial crack propagates in two opposite directions simultaneously along the curved line to clearly and quickly cut the non-metallic material, so that no chip or no particles are generated and thermal shock is reduced.

That is, according to the present invention, a corner of the non-metallic material is prevented from being fractured, chips or particles are not generated from the cutting section, no thermal shock is applied to the non-metallic material to improve product quality and productivity, and cutting time and cutting expensed may be reduced.

### DESCRIPTION OF DRAWINGS

FIG. 1A is a schematic view showing a conventional method of cutting a tempered glass substrate by using a laser.

FIG. 1B is a schematic view showing a conventional method of cutting a cutting a tempered glass substrate along a curved line by using a laser.

FIG. 2 is a schematic view showing a step of forming an initial crack according to an exemplary embodiment of the present invention.

FIG. 3 is a schematic view showing a step of forming an initial crack according to another exemplary embodiment of the present invention.

FIG. 4 is a cross-sectional view showing a tempered glass substrate with the initial crack.

FIG. 5 is a schematic view showing a step of irradiating a laser beam according to an exemplary embodiment of the present invention.

FIG. 6 is a flow chart illustrating a method of cutting a non-metallic material along a curved line according to an exemplary embodiment of the present invention.

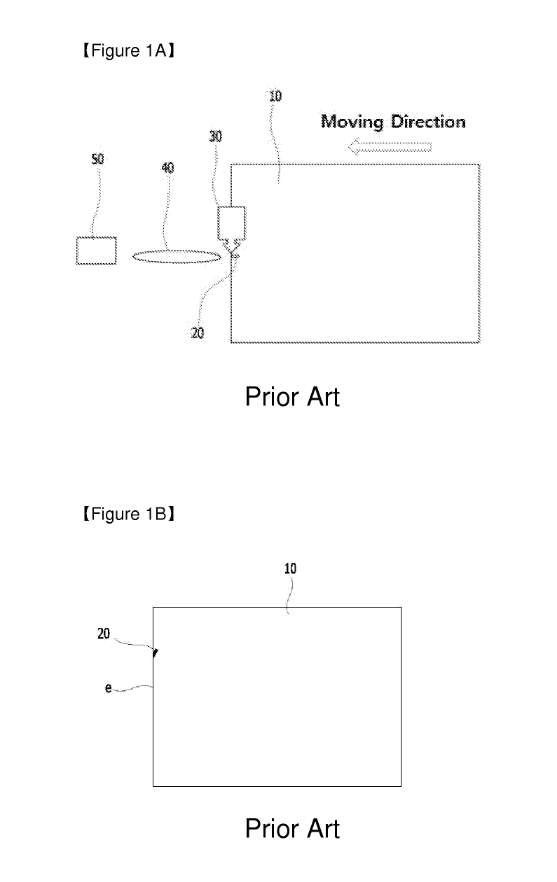

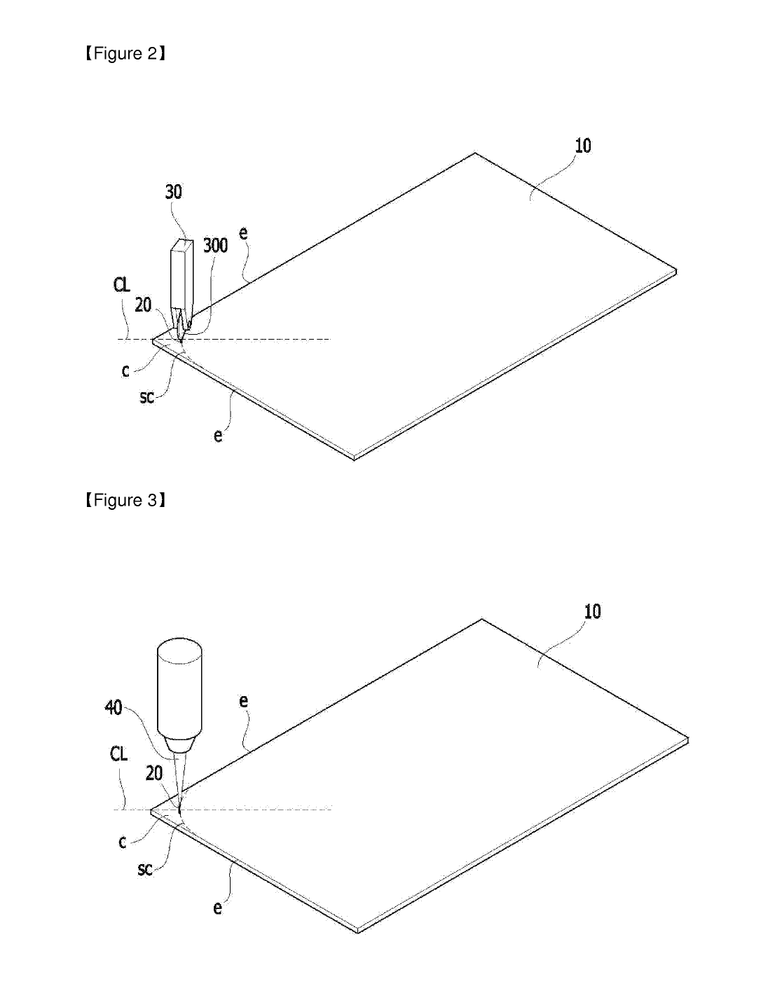

### MODE FOR INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, and/or sections should not be limited by these terms. These terms are only used to distinguish one element, component, region, layer or section from another region, layer or section. Thus, a first element, component, or section discussed below could be termed a second element, component, or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For convenience, same numerals are used for identical or similar elements of an apparatus of cutting a tempered substrate and the conventional one.

Hereinafter, an apparatus of cutting a tempered glass substrate according to an exemplary embodiment of the present invention will be described with reference to the accompanying drawings.

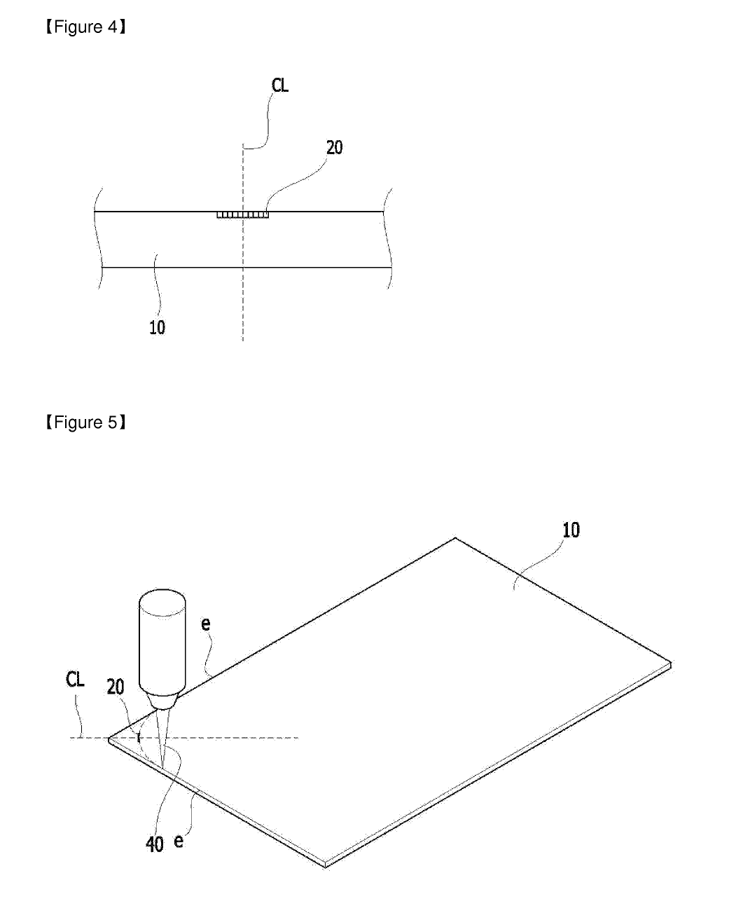

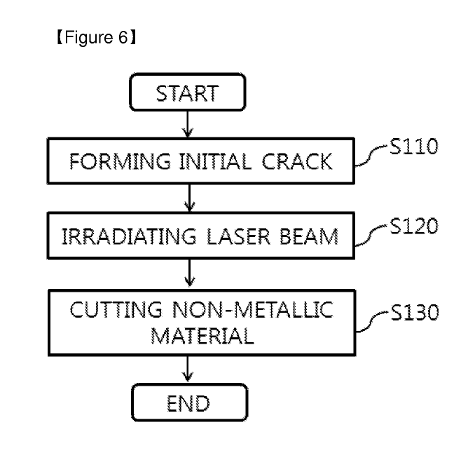

FIG. 2 is a schematic view showing a step of forming an initial crack according to an exemplary embodiment of the present invention, FIG. 3 is a schematic view showing a step of forming an initial crack according to another exemplary embodiment of the present invention, FIG. 4 is a cross-sectional view showing a tempered glass substrate with the initial crack, FIG. 5 is a schematic view showing a step of irradiating a laser beam according to an exemplary embodiment of the present invention, and FIG. 6 is a flow chart illustrating a method of cutting a non-metallic material along a curved line according to an exemplary embodiment of the present invention.

Referring to FIG. 2 through FIG. 6, a method of cutting a non-metallic material along a curved line according to an exemplary embodiment of the present invention, an initial crack 20 is formed on a curved line sc in a corner portion c, along which a non-metallic material 10 is cut, to have a fixed depth (step S110).

For example, the non-metallic material 10 that is to be cut along the curved line sc may be a tempered glass substrate.

The initial crack 20 may be symmetrically formed with respect to a center line CL dividing a corner c of the non-metallic material 10 along the curved line sc to have a fixed depth.

The initial crack 20 is on the curved line sc. The initial crack 20 is formed on the surface of the non-metallic material 10 along the curved line sc not to extend to edge portions e of the non-metallic material 10. That is, the initial crack 20 is formed such that the initial crack 20 is not extend to two opposite end portions of the curved line sc.

That is, the initial crack 20 is not formed at the edge portion e of the non-metallic material 10 but on a surface of the non-metallic material 10 near the center line CL diving the corner c.

Therefore, the edge portion e of the non-metallic material is not fractured in forming the initial crack 20.

In detail, according to the conventional method of cutting a non-metallic material along a curved line, the initial crack is formed at the edge portion e of the non-metallic material 10, which is most weak portion of the non-metallic material 10. Therefore, the edge portion e of the non-metallic material 10 is often fractured to generate chips or particles. Therefore, cutting quality is deteriorated.

However, according to the method of cutting a non-metallic material along a curved line of the present invention, the initial crack 20 is formed on the surface of the non-metallic material 10 near the center line CL diving the corner c, which is most strong portion. Therefore, the edge portions e of the non-metallic material 10 is not fractured not to generate chips or particles in forming the initial crack 20.

The initial crack 20 may be formed on the surface of the non-metallic material 10 through a contact method. For example, a wheel 300 of an initial cracker 30 may make contact with a surface of the non-metallic material 10, when the wheel 300 rotates to form the initial crack 20.

Alternatively, the initial crack 20 may be is formed on the surface of the non-metallic material 10 through a non-contact method. For example, a laser beam 40 may be irradiated onto the surface of the non-metallic material 10 to form the initial crack 20.

The initial crack 20 may have the same curvature as the curved line sc. The initial crack 20 may be formed to be symmetrical with respect to the center line CL dividing the corner c of the non-metallic material 10. Both sides of the initial crack 20 may have the same depth with respect to the center line CL. Therefore, when the initial crack 20 propagates, the initial crack propagates towards two opposite ends of the curved line sc along the curved line sc, so that the initial crack may be arrive at the two edge portions e of the non-metallic material 10 simultaneously.

After forming the initial crack 20 having the same curvature as the curved line sc along which the non-metallic material is cut and being symmetrical with respect to the center line CL diving the corner c, a laser beam 40 is irradiated onto the surface of the non-metallic material 10 along the center line sc (step S120).

For example, the laser beam 40 may be irradiated onto the surface of the non-metallic material 10 along the curved line sc only once.

Alternatively, the laser beam 40 may be irradiated onto the surface of the non-metallic material 10 along the curved line sc several times in accordance with quality and thickness of the non-metallic material 10 and curvature of the curved line SC.

When the laser beam 40 is irradiated onto the surface of the non-metallic material 10 along the curved line sc at least once, thermal impact is applied to the non-metallic material, so that crack propagates from the initial crack 20 toward the two edge portions e of the non-metallic material 10 along the curved line sc in both directions, so that the non-metallic material is cut along the curved line sc (step S130).

Hereinafter, the advantages effects of the method of cutting a non-metallic material along a curved line according to an exemplary embodiment of the present invention will be explained referring to FIG. 2 through FIG. 6.

Referring to FIG. 2 through FIG. 6, according to the method of cutting a non-metallic material along a curved line, the initial crack 20 is formed not at the edge portions e of the non-metallic material 10, which is most weak portion that is easily fractured, but on a center portion of the curved line sc of the surface of the non-metallic material 10, which is relatively strong.

Therefore, the edge portions e of the non-metallic material 10 is not fractured or damaged in forming the initial crack 20.

Further, the initial crack 20 is formed along the curved line sc such that both sides of the initial crack 20 with respect to the center line CL dividing the corner c has substantially same depth and length. As a result, when the laser beam 40 is irradiated along the curved line sc, thermal impact is applied so that the crack propagates from the initial crack 20 toward both edge portions e of the non-metallic material 10 along the curved line sc simultaneously. Therefore, the non-metallic material may be clearly and quickly cut.

That is, when the laser beam 40 is irradiated onto the non-metallic material 10 along the curved line sc, the crack propagates from the initial crack 20 toward the both edge portions e of the non-metallic material 10 simultaneously since the both sides of initial crack 20 are symmetrically formed with respect to the center line CL diving the corner c to have the same length and depth so that chips and particles are not generated and the non-metallic material do not have thermal damages.

Further, when the initial crack 20 is formed such that the initial crack 20 and the curved line sc have the same curvature, and when the initial crack 20 is formed at the center of the curved line sc, the non-metallic material 10 is clearly and quickly cut along the curved line sc.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of cutting a non-metallic material along a curved line, the method comprising:
forming an initial crack on a surface of a non-metallic material such that the initial crack is disposed on a curved line along which the non-metallic material is cut; and
irradiating a laser beam along the curved line to apply thermal shock to propagate along the curved line to cut the non-metallic material along the curved line.

2. The method of claim 1, wherein the initial crack is symmetrically formed with respect to a center line dividing a corner of the non-metallic material along the curved line to have a fixed depth.

3. The method of claim 1, wherein the initial crack is formed on the surface of the non-metallic material along the curved line not to extend to two opposite ends of the curved line.

4. The method of claim 1, wherein the initial crack is formed on the surface of the non-metallic material through a contact method.

5. The method of claim 4, wherein the initial crack is formed by contacting rotating wheel to the surface of the non-metallic material.

6. The method of claim 1, wherein the initial crack is formed on the surface of the non-metallic material through a non-contact method.

7. The method of claim 6, wherein the initial crack is formed by irradiating laser beam.

8. The method of claim 1, wherein the laser beam is irradiated along the curved line at least one time.
